(19) United States
(12) Patent Application Publication
(10) Pub. No.: US 2009/0194416 A1
(43) Pub. Date: Aug. 6, 2009

(54) Potentiometric biosensor for detection of creatinine and forming method thereof

(75) Inventors: Shen-Kan Hsiung, Tao-Yuan (TW); Jung-Chuan Chou, Tao-Yuan (TW); Tai-Ping Sun, Tao-Yuan (TW); Nien-Hsuan Chou, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Taoyuan (TW)

(21) Appl. No.: 12/024,066

(22) Filed: Jan. 31, 2008

(51) Int. Cl. G01N 27/327; B05D 5/12

(52) U.S. Cl. 204/403.14; 204/403.01; 427/58

(57) ABSTRACT

The present invention discloses a potentiometric biosensor for detecting creatinine, and the forming method thereof. The disclosed biosensor comprises a substrate, a working electrode formed on the substrate, a first reference electrode formed on the substrate, a second reference electrode formed on the substrate, and a packaging structure which separates the above-mentioned three electrodes. The working electrode comprises creatinine iminohydrolase (CIH). The detection signal is transmitted out from the biosensor for further processing through a wire or an exposed surface. The disclosed biosensor is replaceable.

### BACKGROUND OF THE INVENTION

1. Field of the Invention

The present invention is generally related to biosensors and the fabrication method thereof, and more particularly, a potentiometric biosensor for detection of creatinine and forming method thereof

2. Description of the Prior Art

Biosensor is commonly defined as an analytical device which combines energy converter with immobilized biomolecules for detecting specific chemicals via the interaction between biomolecules and such specific chemicals. The above-mentioned energy converter can be a potentiometer, a galvanometer, an optical fiber, a surface plasma resonance, a field-effect transistor, a piezoelectric quartz crystal, a surface acoustic wave, and so on. The field-effect transistor which can be fabricated to form the miniaturized component via mature semiconductor process has become an important technique for developing light and portable products, which is the current market trend.

At present, the commercial biosensors based on field-effect transistors detect specific chemicals utilizing amperometeric technology. The principle of amperometeric technology is detecting a small electric current in organisms. Amperometric biosensors have fast response, but the read circuit needs an additional bias voltage to convert the signals. Therefore, the fabrication of amperometric biosensors requires a more complicated design and higher costs. A redox reaction occurs when the amperometric biosensors detect specific chemicals via the interaction between biomolecules and such specific chemicals, and it produces a small electric current which flows through the surface of sensor window, which would destroy biological molecules (such as enzymes), and hence affect the follow-up use of enzymes regarding chemical response capability. Moreover, the biosensors based on field-effect transistors are mostly produced by the semiconductor manufacturing process that needs strict conditions (such as the need for high vacuum environment, etc.), which results in high costs of production.

On other hand, with the rise of medical and health consciousness, and biosensors developed for medical purpose is groundless and baseless (such as measurement of the creatinine concentration in human serum). How to make the biosensors having simple structure, good stability, and replaceable with low cost in medical purpose has become the current trend in sensor development.

### SUMMARY OF THE INVENTION

In accordance with the present invention, a potentiometric biosensor for detection of creatinine and forming method thereof is provided.

The present invention further discloses a potentiometric biosensor for detection of creatinine. The potentiometric biosensor revealed in this invention is for detecting the content of creatinine in human serum and urine, and it is an important parameter of great interest in biomedical and clinical analysis that is used for the determination of the diagnosis of renal, thyroid and muscle function.

The present invention discloses a potentiometric biosensor based on field-effect transistors which can be fabricated to form the miniaturized component via semiconductor process. The potentiometric biosensor of the present invention doesn't need an additional bias voltage to convert the signals. The disclosed biosensor comprises a substrate, a working electrode formed on the substrate, a first reference electrode formed on the substrate, a second reference electrode formed on the substrate, and a packaging structure which separates the above-mentioned three electrodes. The working electrode comprises creatinine iminohydrolase (CIH). The detection signal is transmitted out from the biosensor for further processing through a wire or an exposed surface. The disclosed biosensor is replaceable.

### BRIEF DESCRIPTION OF THE DRAWINGS

FIG. 1 is a schematic diagram of the potentiometric biosensor for detection of creatinine according to the first embodiment of the present invention;

FIG. 2 is a schematic diagram of the potentiometric biosensor for detection of creatinine according to the second example of the first embodiment of the present invention;

FIG. 3 is a schematic diagram of the potentiometric biosensor for detection of creatinine according to the third example of the first embodiment of the present invention;

FIG. 4A is a schematic diagram of the potentiometric biosensor for detection of creatinine according to the fourth example of the first embodiment of the present invention;

FIG. 4B is a schematic diagram of the potentiometric biosensor for detection of creatinine according to the fifth example of the first embodiment of the present invention;

FIG. 5 is a schematic diagram of the potentiometric biosensor for detection of creatinine according to the second embodiment of the present invention

FIG. 6 is a schematic diagram of the potentiometric biosensor for detection of creatinine according to the third embodiment of the present invention

FIG. 7 is a flow chart of the method for forming a potentiometric biosensor to detect creatinine according to the present invention.

### DESCRIPTION OF THE PREFERRED EMBODIMENTS

What is probed into the invention is a potentiometric biosensor for detection of creatinine. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following specification. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

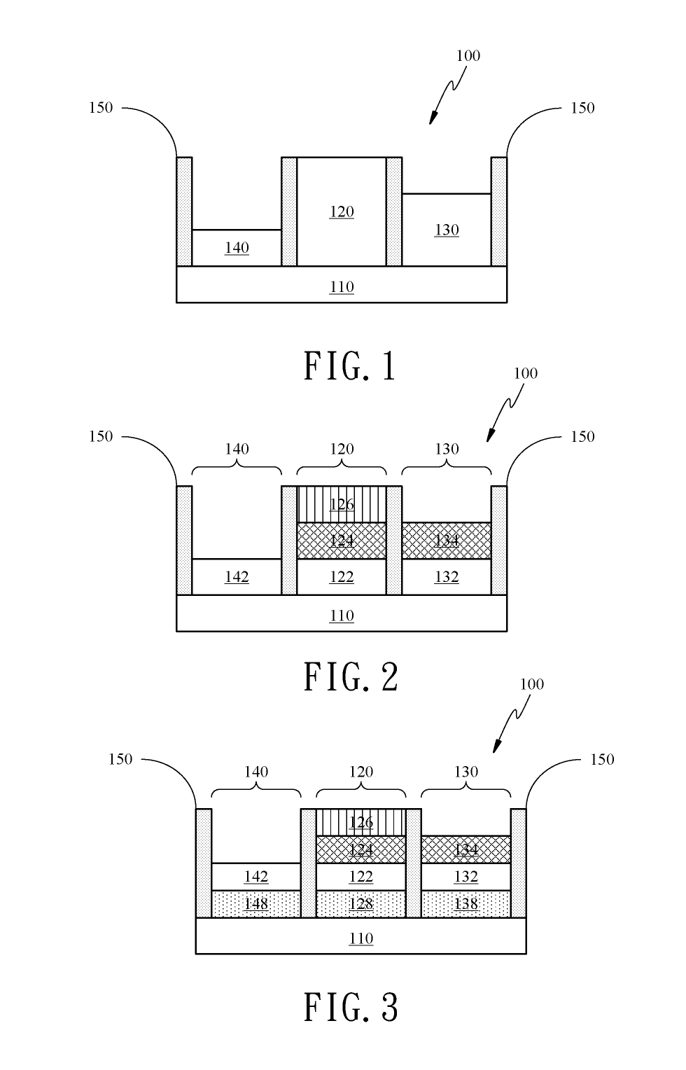

As shown in FIG. 1, a first embodiment of the present invention discloses a potentiometric biosensor 100 for detection of creatinine, comprising a substrate 110, a working electrode 120 formed on the substrate 110, a first reference electrode 130 formed on the substrate 110, a second reference electrode 140 formed on the substrate 110, and a packaging structure 150, which separates the above-mentioned three electrodes. The material of above-mentioned substrate 110 comprises one selected from the group consisting of the following: insulating materials (such as insulating glass), non-insulated materials (such as indium-tin oxide glass and non-insulated tin oxide glass) and flexible materials (such as polyethylene terephthalate (PET)). The above-mentioned packaging structure 150 is epoxy resin. The best measurement range of the biosensor 100 is between pH6 to pH8.

As shown in FIG. 2, in this embodiment of the present invention, the above-mentioned working electrode 120, comprising a first sensing layer 122 formed on the substrate 110, a first ion-selective layer 124 formed on the first sensing layer 122, and a first enzyme layer 126 formed on the first ion-selective layer 124. The first sensing layer 122 is a non-insulated solid ion which comprises one selected from the group consisting of the following: tin dioxide, titanium dioxide, and titanium nitride. The above-mentioned first ion-selective layer 124 is an ammonium ion-selective layer, comprising carboxylated polyvinylchloride (PVC-COOH). The above-mentioned first enzyme layer 126 comprises creatinine iminohydrolase (CIH). The first enzyme layer 126 is immobilized on the first ion-selective layer 124 via entrapment method by polyvinyl alcohol containing stilbazolium group (PVA-SbQ).

As shown in FIG. 3, a first example of the present embodiment is shown that the working electrode 120 further comprises a first conducting layer 128 which lies between the substrate 110 and the first sensing layer 122 for outward transmission of a detection signal, and the first conducting layer 128 possesses a low impedance as to enhance the transmission efficiency of the detection signal. Moreover, the first conducting layer 128 comprises one selected from the group consisting of the following: copper, carbon, silver, aurum, silver chloride, Indium tin oxides (ITO).

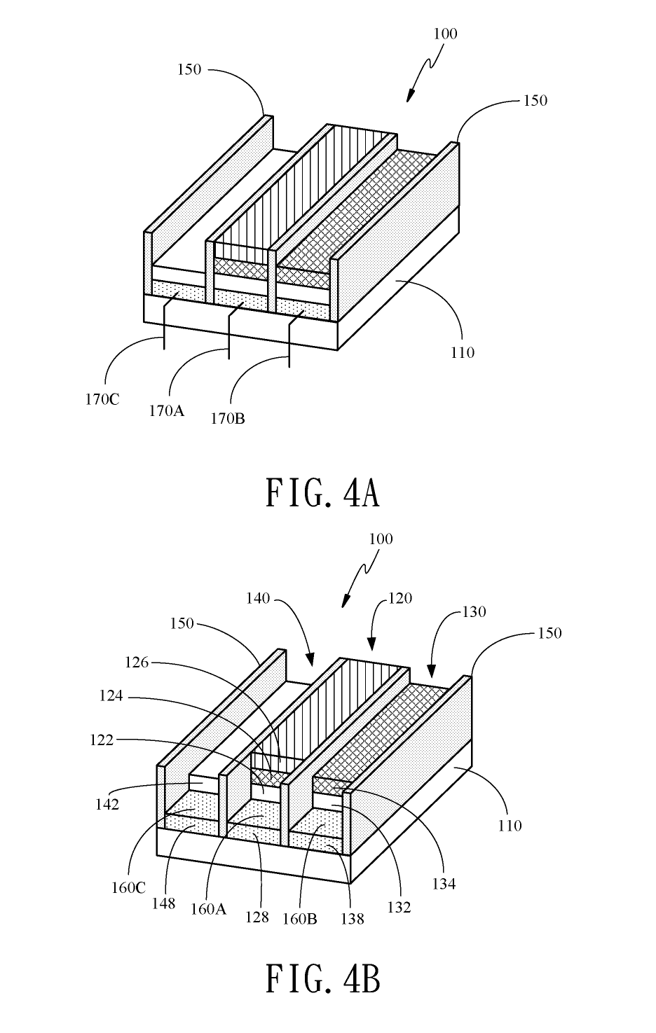

As shown in FIG. 4A, a second example of the present embodiment is shown that the working electrode 120 further comprises a wire 170A connected to the first conducting layer 128 to facilitate the transmission of the detection signal, and the wire 170A comprises one selected from the group consisting of the following: copper, carbon, silver, aurum, silver chloride, Indium tin oxides (ITO). On other hand, as shown in FIG. 4B, a third example of the present embodiment is shown that the first conducting layer 128 comprises an exposed surface 160A to electrically couple with the external world and for outward transmission of the detection signal.

Now referring back to FIG. 2, in this embodiment of the present invention, the first reference electrode 130 is an ammonium ion-selective electrode which comprises a second sensing layer 132 formed on the substrate 110, and a second ion-selective layer 134 formed on the second sensing layer 132. Therefore, as shown in FIG. 3, the first reference electrode 130 may further comprises a second conducting layer 138 which lies between the substrate 110 and the second sensing layer 132 for outward transmission of another detection signal, and the second conducting layer 138 possesses a low impedance as to enhance the transmission efficiency of the detection signal. Moreover, the second conducting layer 138 comprises one selected from the group consisting of the following: copper, carbon, silver, aurum, silver chloride, Indium tin oxides (ITO). The second sensing layer 132 is a non-insulated solid ion which comprises one selected from the group consisting of the following: tin dioxide, titanium dioxide, and titanium nitride. The second ion-selective layer 134 is an ammonium ion-selective layer which comprises carboxylated polyvinylchloride (PVC-COOH).

As shown in FIG. 4A, the first reference electrode 130 further comprises a wire 170B connected to the second conducting layer 138 to facilitate the transmission of the detection signal, and the wire 170B comprises one selected from the group consisting of the following: copper, carbon, silver, aurum, silver chloride, Indium tin oxides (ITO). On other hand, as shown in FIG. 4B, the second conducting layer 138 comprises an exposed surface 160B to electrically couple with the external world and for outward transmission of the detection signal.

Referring back to FIG. 2 again, in this embodiment of the present invention, the second reference electrode 140 is as hydrogen ion-selective electrode, comprising a third sensing layer 142 formed on the substrate 110. Moreover, as shown in FIG. 3, the second reference electrode 140 may further comprises a third conducting layer 148 which lies between the substrate 110 and the third sensing layer 142 for outward transmission of a third detection signal, and the third conducting layer 148 possesses a low impedance as to enhance the transmission efficiency of the detection signal. Furthermore, the third conducting layer 148 comprises one selected from the group consisting of the following: copper, carbon, silver, aurum, silver chloride, Indium tin oxides (ITO). The third sensing layer 142 is a non-insulated solid ion which comprises one selected from the group consisting of the following: tin dioxide, titanium dioxide, and titanium nitride.

As shown in FIG. 4A, the second reference electrode 140 further comprises a wire 170C connected to the third conducting layer 148 to facilitate the transmission of the third detection signal, and the wire 170C comprises one selected from the group consisting of the following: copper, carbon, silver, aurum, silver chloride, Indium tin oxides (ITO). On other hand, as shown in FIG. 4B, the third conducting layer 148 comprises an exposed surface 160C to electrically couple with the external world and for outward transmission of the third detection signal.

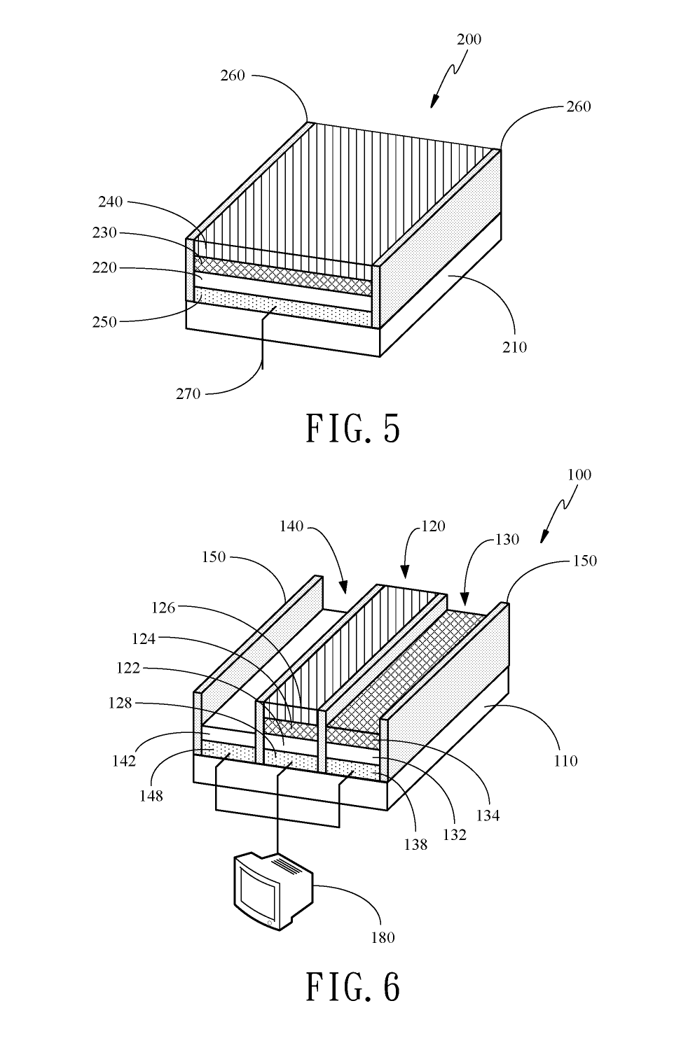

As shown in FIG. 5, a second embodiment of the present invention discloses a working electrode 200 for detection of creatinine, comprising a substrate 210, a sensing layer 220 formed on the substrate 210, an ion-selective layer 230 formed on the sensing layer 220, and an enzyme layer 240 formed on the ion-selective layer 230. The sensing layer 220 is a non-insulated solid ion which comprises one selected from the group consisting of the following: tin dioxide, titanium dioxide, and titanium nitride. The ion-selective layer 230 is an ammonium ion-selective layer which comprises carboxylated polyvinylchloride (PVC-COOH). The above-mentioned enzyme layer 240 comprises creatinine iminohydrolase (CIH). The enzyme layer 240 is immobilized on the ion-selective layer 230 via entrapment method by photocrosslinkable polyvinyl alcohol containing stilbazolium group (PVA-SbQ). The working electrode 200 further comprises a packaging structure 260 which is epoxy resin.

An example of the second embodiment is shown that the working electrode 200 further comprises a conducting layer 250 which lies between the substrate 210 and the sensing layer 220 for outward transmission of detection signal, and the conducting layer 250 possesses a low impedance as to enhance the transmission efficiency of the detection signal. Moreover, the conducting layer 250 comprises one selected from the group consisting of the following: copper, carbon, silver, aurum, silver chloride, Indium tin oxides (ITO). Another example of the second embodiment is shown that the conducting layer 250 comprises an exposed surface to electrically couple with the external world and for outward transmission of the detection signal.

Furthermore, a futher example of the second embodiment is shown that the working electrode 200 further comprises a wire 270 connected to the conducting layer 250 to facilitate the transmission of the detection signal, and the wire 270 comprises one selected from the group consisting of the following: copper, carbon, silver, aurum, silver chloride, Indium tin oxides (ITO).

As shown in FIG. 6, a third embodiment of the present invention discloses a potentiometric biosensor 100 for detection of creatinine, comprising a substrate 110, a working electrode 120 formed on the substrate 110, a first reference electrode 130 formed on the substrate 110, a second reference electrode 140 formed on the substrate 110, a packaging structure 150, which separates the above-mentioned three electrodes, and a judgment module 180 to electrically couple with a potentiometric biosensor 100. The judgment module 180 receives signals from the first reference electrode 130, the second reference electrode 140, and the working electrode 120 via wire 170B, wire 170C, and wire 170A, and to calculate the concentration of creatinine.

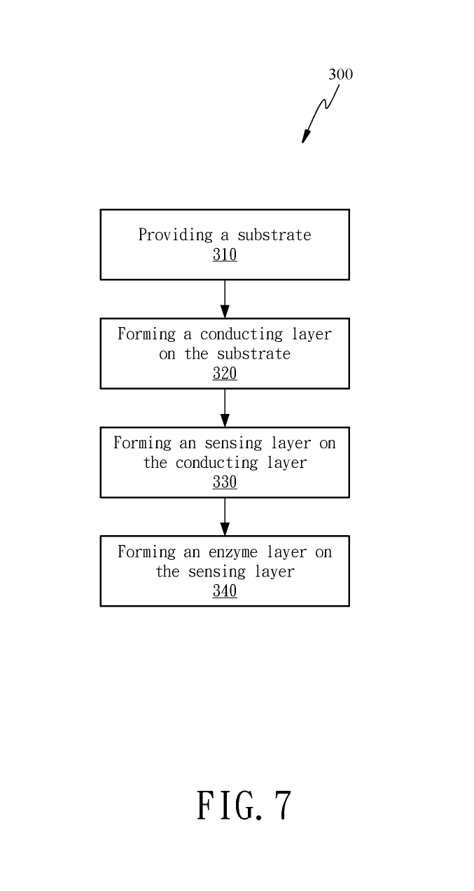

As shown in FIG. 7, the present invention discloses a method for forming a working electrode of a potentiometric biosensor for detecting creatinine. The flow chart 300 comprises four major steps. The first step 310 is providing a substrate, and the second step 320 is forming a conducting layer on the substrate, and the third step 330 is forming a sensing layer on the conducting layer, and the fourth step 340 is forming an enzyme layer on the sensing layer. An example of this embodiment is shown that the method for forming the working electrode further comprises providing a wire after the formation of the conducting layer on the substrate, the wire being connected to the conducting layer for the transmission of a detection signal. Moreover, another example of this embodiment is shown that the method for forming the working electrode further comprises the step of, after the formation of the conducting layer on the substrate, forming an exposed surface on the conducting layer for the transmission of the detection signal. The above-mentioned enzyme layer is immobilized by covalent bonding method or entrapment method. The sensing layer is formed by deposition of tin oxide on the substrate through magnetron sputtering, and the thickness of the sensing layer is about 1500 angstrom to 2500 angstrom.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A potentiometric biosensor for detection of creatinine, comprising:
a substrate;
a working electrode formed on said substrate;
a first reference electrode formed on said substrate; and
a second reference electrode formed on said substrate.
a packaging structure, which separates the above-mentioned three electrodes.

2. The potentiometric biosensor for detection of creatinine according to claim 1, wherein said substrate comprises one selected from the group consisting of the following: insulating glass, non-insulated indium-tin oxide glass, non-insulated tin oxide glass and polyethylene terephthalate (PET).

3. The potentiometric biosensor for detection of creatinine according to claim 1, wherein said working electrode, comprising:
a first sensing layer formed on said substrate;
a first ion-selective layer formed on said first sensing layer; and
a first enzyme layer formed on said first ion-selective layer.

4. The potentiometric biosensor for detection of creatinine according to claim 3, wherein said first sensing layer is a non-insulated solid ion, comprising one selected from the group consisting of the following: tin dioxide, titanium dioxide, and titanium nitride.

5. The potentiometric biosensor for detection of creatinine according to claim 3, wherein said first ion-selective layer is an ammonium ion-selective layer, comprising carboxylated polyvinylchloride (PVC-COOH).

6. The potentiometric biosensor for detection of creatinine according to claim 3, wherein said first enzyme layer comprises creatinine iminohydrolase (CIH).

7. The potentiometric biosensor for detection of creatinine according to claim 3, wherein said working electrode further comprises a first conducting layer which lies between said substrate and said first sensing layer for outward transmission of a detection signal, and said first conducting layer possesses a low impedance as to enhance the transmission efficiency of said detection signal, and said first conducting layer comprises one selected from the group consisting of the following: copper, carbon, silver, aurum, silver chloride, Indium tin oxides (ITO).

8. The potentiometric biosensor for detection of creatinine according to claim 7, wherein said working electrode further comprises a wire connected to said first conducting layer to facilitate the transmission of said detection signal, and said wire comprises one selected from the group consisting of the following: copper, carbon, silver, aurum, silver chloride, Indium tin oxides (ITO).

9. The potentiometric biosensor for detection of creatinine according to claim 3, wherein said first enzyme layer is immobilized on said first ion-selective layer via entrapment method by photocrosslinkable polyvinyl alcohol containing stilbazolium group (PVA-SbQ).

10. The potentiometric biosensor for detection of creatinine according to claim 7, wherein said first conducting layer comprises an exposed surface to electrically couple with the external world and for outward transmission of said detection signal.

11. The potentiometric biosensor for detection of creatinine according to claim 1, wherein said first reference electrode is an ammonium ion-selective electrode, comprising:
a second conducting layer formed on said substrate;
a second sensing layer formed on said second conducting layer; and
a second ion-selective layer formed on said second sensing layer.

12. The potentiometric biosensor for detection of creatinine according to claim 11, wherein said second conducting layer comprises an exposed surface to electrically couple with the external world and for outward transmission of a detection signal, and said second conducting layer possesses a low impedance as to enhance the transmission efficiency of said detection signal, and said second conducting layer comprises one selected from the group consisting of the following: copper, carbon, silver, aurum, silver chloride, Indium tin oxides (ITO).

13. The potentiometric biosensor for detection of creatinine according to claim 11, wherein said first reference electrode further comprises a wire connected to said second conducting layer to facilitate the transmission of the detection signal, and said wire comprises one selected from the group consisting of the following: copper, carbon, silver, aurum, silver chloride, Indium tin oxides (ITO).

14. The potentiometric biosensor for detection of creatinine according to claim 11, wherein said second sensing layer is a non-insulated solid ion, comprising one selected from the group consisting of the following: tin dioxide, titanium dioxide, and titanium nitride.

15. The potentiometric biosensor for detection of creatinine according to claim 11, wherein said second ion-selective layer is an ammonium ion-selective layer, comprising carboxylated polyvinylchloride (PVC-COOH).

16. The potentiometric biosensor for detection of creatinine according to claim 1, wherein said second reference electrode is a hydrogen ion-selective electrode, comprising:
a third conducting layer formed on said substrate; and
a third sensing layer formed on said third conducting layer.

17. The potentiometric biosensor for detection of creatinine according to claim 16, wherein said third conducting layer comprises an exposed surface to electrically couple with the external world and for outward transmission of a detection signal, and said third conducting layer possesses a low impedance as to enhance the transmission efficiency of said detection signal, and said third conducting layer comprises one selected from the group consisting of the following: copper, carbon, silver, aurum, silver chloride, Indium tin oxides (ITO).

18. The potentiometric biosensor for detection of creatinine according to claim 16, wherein said second reference electrode further comprises a wire connected to said third conducting layer to facilitate the transmission of said detection signal, and said wire comprises one selected from the group consisting of the following: copper, carbon, silver, aurum, silver chloride, Indium tin oxides (ITO).

19. The potentiometric biosensor for detection of creatinine according to claim 16, wherein said third sensing layer is a non-insulated solid ion, comprising one selected from the group consisting of the following: tin dioxide, titanium dioxide, and titanium nitride.

20. A working electrode for detection of creatinine, comprising:
a substrate;
a sensing layer formed on said substrate;
an ion-selective layer formed on said sensing layer; and
a enzyme layer formed on said ion-selective layer.

21. The working electrode for detection of creatinine according to claim 20, wherein said sensing layer is a non-insulated solid ion, comprising one selected from the group consisting of the following: tin dioxide, titanium dioxide, and titanium nitride.

22. The working electrode for detection of creatinine according to claim 20, wherein said ion-selective layer is an ammonium ion-selective layer, comprising carboxylated polyvinylchloride (PVC-COOH).

23. The working electrode for detection of creatinine according to claim 20, wherein said enzyme layer comprises creatinine iminohydrolase (CIH).

24. The working electrode for detection of creatinine according to claim 20, wherein said working electrode further comprises a conducting layer which lies between said substrate and said sensing layer for outward transmission of a detection signal, and said conducting layer possesses a low impedance as to enhance the transmission efficiency of said detection signal, and said conducting layer comprises one selected from the group consisting of the following: copper, carbon, silver, aurum, silver chloride, Indium tin oxides (ITO).

25. The working electrode for detection of creatinine according to claim 24, wherein said working electrode further comprises a wire connected to said conducting layer to facilitate the transmission of the detection signal, and said wire comprises one selected from the group consisting of the following: copper, carbon, silver, aurum, silver chloride, Indium tin oxides (ITO).

26. The working electrode for detection of creatinine according to claim 20, wherein said enzyme layer is immobilized on said ion-selective layer via entrapment method by photocrosslinkable polyvinyl alcohol containing stilbazolium group (PVA-SbQ).

27. The working electrode for detection of creatinine according to claim 24, wherein said conducting layer comprises an exposed surface to electrically couple with the external world and for outward transmission of the detection signal.

28. A method for forming a working electrode to detect creatinine, comprising:
providing a substrate;
forming a conducting layer on said substrate;
forming a sensing layer on said conducting layer;
forming an ion-selective layer on said sensing layer; and
forming an enzyme layer on said ion-selective layer.

29. The method for forming a working electrode to detect creatinine according to claim 28, wherein said sensing layer is formed by deposition of tin oxide on said substrate through magnetron sputtering.
